(19) United States
(12) Patent Application Publication
(10) Pub. No.: US 2026/0120721 A1
(43) Pub. Date: Apr. 30, 2026

(54) VIDEO PROCESSING METHOD AND RELATED DEVICES

(71) Applicant: Beijing Zitiao Network Technology Co., Ltd., Beijing (CN)

(72) Inventors: Junfeng HE, Beijing (CN); Weidong Yang, Beijing (CN); Jiepeng Cen, Beijing (CN); Lingfu Li, Beijing (CN)

(21) Appl. No.: 19/373,014

(22) Filed: Oct. 29, 2025

(30) Foreign Application Priority Data
Oct. 29, 2024 (CN) 202411524305.2

(51) Int. Cl. G11B 27/036; G06F 40/279; G06V 10/764; G11B 27/34

(52) U.S. Cl. CPC G11B 27/036; G06F 40/279; G06V 10/764; G11B 27/34

(57) ABSTRACT

The present disclosure provides a video processing method and related devices. The method includes: acquiring attribute information of a target object and an initial video, where the initial video includes audio data related to the target object; obtaining a video category and a video effect list of the initial video based on a target text corresponding to the audio data and the attribute information; determining a target material corresponding to an effect object based on the video category and an effect material label; and adding the target material to the initial video based on a target timestamp of the text segment in the audio data, to obtain a target video.

### CROSS-REFERENCE TO RELATED APPLICATIONS

This application claims priority to Chinese Application No. 202411524305.2 filed October. 29, 2024, the disclosure of which is incorporated herein by reference in its entity.

### FIELD

The present disclosure relates to the technical field of video processing, and in particular, to a video processing method and related devices.

### BACKGROUND

Video processing may enrich visual and auditory effects of videos by matching and combining materials such as texts, music, sound effects, stickers, and effects, thereby making the conveyance of information and emotions more prominent.

### SUMMARY

The present disclosure provides a video processing method and related devices.

In a first aspect of the present disclosure, a video processing method is provided, and includes:

acquiring attribute information of a target object and an initial video, where the initial video includes audio data related to the target object;

obtaining a video category and a video effect list of the initial video based on a target text corresponding to the audio data and the attribute information, where the video effect list includes at least one effect object, and the effect object includes an effect attribute label related to a preset effect attribute, and a text segment corresponding to at least part of the audio data;

determining a target material corresponding to the effect object based on the video category and the effect material label; and

adding the target material to the initial video based on a target timestamp of the text segment in the audio data, to obtain a target video.

In a second aspect of the present disclosure, a video processing apparatus is provided, and includes:

an acquiring module, configured to acquire attribute information of a target object and an initial video, where the initial video includes audio data related to the target object;

an effect list module, configured to obtain, in language, a video category and a video effect list of the initial video based on a target text corresponding to the audio data and the attribute information, where the video effect list includes at least one effect object, and the effect object includes an effect attribute label related to a preset effect attribute, and a text segment corresponding to at least part of the audio data;

a material determination module, configured to determine a target material corresponding to the effect object based on the video category and the effect material label; and

a material addition module, configured to add the target material to the initial video based on a target timestamp of the text segment in the audio data, to obtain a target video.

In a third aspect of the present disclosure, an electronic device is provided, and includes one or more processors, a memory, and one or more programs. The one or more programs are stored in the memory and executed by the one or more processors. The program includes instructions used to perform the method in the first aspect.

In a fourth aspect of the present disclosure, a non-volatile computer-readable storage medium including a computer program is provided. The computer program, when executed by one or more processors, causes the processor to perform the method in the first aspect.

In a fifth aspect of the present disclosure, a computer program product is provided, and includes computer program instructions. The computer program instructions, when executed on a computer, cause the computer to perform the method in the first aspect.

### BRIEF DESCRIPTION OF THE DRAWINGS

In order to describe the technical solutions of the present disclosure or the related art more clearly, the accompanying drawings required for describing the embodiments or the related art will be briefly introduced below. Apparently, the accompanying drawings in the following description are merely embodiments of the present disclosure, and those of ordinary skill in the art may also obtain other accompanying drawings according to these accompanying drawings without creative efforts.

FIG. 1 is a schematic diagram of a video processing architecture according to an embodiment of the present disclosure.

FIG. 2 is a schematic diagram of a hardware structure of an exemplary electronic device according to an embodiment of the present disclosure.

FIG. 3 is a schematic flowchart of a video processing method according to an embodiment of the present disclosure.

FIG. 4 is a schematic diagram of a video processing method according to an embodiment of the present disclosure.

FIG. 5 is a schematic diagram of a video processing apparatus according to an embodiment of the present disclosure.

### DETAILED DESCRIPTION OF EMBODIMENTS

To have a more clear understanding of objectives, technical solutions, and advantages of the present disclosure, the present disclosure is further described in detail in conjunction with specific embodiments and with reference to accompanying drawings below.

It should be noted that unless otherwise defined, the technical or scientific terms used in the embodiments of the present disclosure should have ordinary meanings understood by those of ordinary skill in the art of the present disclosure. "First", "second", and similar words used in the embodiments of the present disclosure are merely used for distinguishing different components instead of representing any sequence, quantity, or importance. Similar words such as "include" or "contain" are intended to indicate that elements or objects appearing in front of the word cover elements or objects listed behind the word, as well as equivalents thereof, without excluding other elements or objects. Similar words such as "connected" or "linked" are not limited to physical or mechanical connections, but may include electrical connections, regardless of direct connections or indirect connections. "Up", "down", "left", "right", and the like are merely used to indicate a relative positional relationship, and the relative positional relationship may change accordingly when an absolute position of a described object changes.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, according to the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the method for sending the prompt information to the user may be, for example, a pop-up window, in which the prompt information may be presented in text. Further, the pop-up window may further carry a selection control for the user to choose whether to "agree" or "disagree" to provide the personal information to the electronic device.

It should be understood that the above-mentioned process of notifying and acquiring the authorization of the user is only illustrative and does not constitute a limitation on the implementations of the present disclosure, and other methods that satisfy the relevant laws and regulations may also be applied in the implementations of the present disclosure.

Although the existing videos can achieve automatic effect addition, the resulting video effects are unsatisfactory.

According to the video processing method and the related devices provided in the present disclosure, the video category and the effect object with at least one effect attribute label are automatically generated through the attribute information of the target object and the target text corresponding to the audio data, thereby forming the video effect list. Then, the appropriate effect material is selected according to the video category and the effect attribute label to be embedded in the initial video of the target object to obtain the target video. The content quality, viewing experience, and dissemination efficiency of the video can be significantly improved, making the video more appealing and more effective in information transmission.

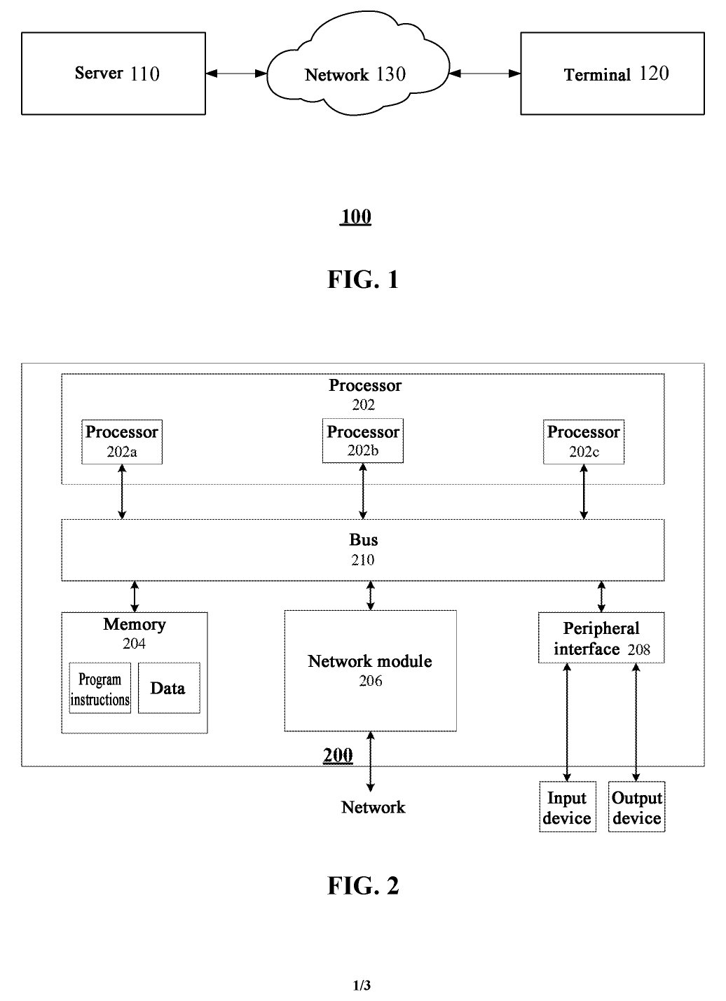

FIG. 1 illustrates a schematic diagram of a video processing architecture according to an embodiment of the present disclosure. Referring to FIG. 1, the video processing architecture 100 may include a server 110, a terminal 120, and a network 130 providing a communication link. The server 110 and the terminal 120 may be connected through the wired or wireless network 130. The server 110 may be an independent physical server, or a server cluster or a distributed system composed of a plurality of physical servers, or may be a cloud server providing basic cloud computing services such as a cloud service, a cloud database, cloud computing, a cloud function, cloud storage, a network service, cloud communication, a middleware service, a security service, and a content delivery network (CDN).

The terminal 120 may be implemented through hardware or software. For example, when the terminal 120 is implemented through the hardware, the terminal 120 may be various electronic devices having display screens and supporting page displaying, including but not limited to a smart phone, a tablet, an e-book reader, a laptop, a desk computer, etc. When the terminal 120 is implemented through the software, the terminal 120 may be installed on the electronic device listed above, and may be implemented as a plurality of software or software modules (e.g., software or software modules configured to provide distributed services), or as a single software or software module. No specific limitations are imposed herein.

It should be noted that a video processing method provided in an embodiment of this application may be performed by the terminal 120 or the server 110. It should be understood that the number of terminals, networks, and servers in FIG. 1 is for an illustrative purpose only, and is not intended to impose limitations. According to implementation needs, there may be any number of terminals, networks, and servers.

FIG. 2 illustrates a schematic diagram of a hardware structure of an exemplary electronic device 200 according to an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are mutually in communication connection within the electronic device 200 through the bus 210.

The processor 202 may be a central processing unit (CPU), a video processor, a neural processing unit (NPU), a microcontroller unit (MCU), a programmable logic device, a digital signal processor (DSP), an application specific integrated circuit (ASIC), or one or more integrated circuits. The processor 202 may be configured to perform functions related to the technology described in the present disclosure. In some embodiments, the processor 202 may further include a plurality of processors integrated into a single logical component. For example, as shown in FIG. 2, the processor 202 may include a plurality of processors 202a, 202b, and 202c.

The memory 204 may be configured to store data (e.g., instructions and computer code). As shown in FIG. 2, the data stored in the memory 204 may include program instructions (e.g., program instructions for implementing the video processing method in this embodiment of the present disclosure) and data to be processed (e.g., the memory may store configuration files for other modules). The processor 202 may also access the program instructions and the data stored in the memory 204 and execute the program instructions to operate the data to be processed. The memory 204 may include a volatile storage apparatus or a non-volatile storage apparatus. In some embodiments, the memory 204 may include a random-access memory (RAM), a read-only memory (ROM), an optical disk, a magnetic disk, a hard drive, a solid state drive (SSD), a flash memory, a memory stick, etc.

The network module 206 may be configured to provide communication between the electronic device 200 and other external devices via a network. The network may be any wired or wireless network capable of transmitting and receiving data. For example, the network may be a wired network, a local wireless network (e.g., Bluetooth, Wi-Fi, and near field communication (NFC)), a cellular network, the Internet, or a combination of the above. It should be understood that the type of network is not limited to the above-mentioned specific examples. In some embodiments, the network module 306 may include any combination of any number of network interface controllers (NICs), radio frequency modules, transceivers, modems, routers, gateways, adapters, cellular network chips, etc.

The peripheral interface 208 may be configured to connect the electronic device 200 with one or more peripheral apparatuses to achieve information input and output. For example, the peripheral apparatus may include an input device such as a keyboard, a mouse, a touchpad, a touchscreen, a microphone, and various sensors, as well as an output device such as a display, a speaker, a vibrator, and an indicator light.

The bus 210 may be configured to transmit information between various components of the electronic device 200 (e.g., the processor 202, the memory 204, the network module 206, and the peripheral interface 208), such as an internal bus (e.g., a processor-memory bus) and an external bus (a USB port and a PCI-E bus).

It should be noted that although the architecture of the above-mentioned electronic device 200 only shows the processor 202, the memory 204, the network module 206, the peripheral interface 208, and the bus 210, in the specific implementation process, the architecture of the electronic device 200 may also include other components necessary for normal execution. In addition, those skilled in the art should understand that the architecture of the above-mentioned electronic device 200 may also only include components necessary for implementing the solutions of the embodiments of the present disclosure, and does not necessarily include all the components shown in the figures.

Video processing may enrich visual and auditory effects of videos by matching and combining materials such as texts, music, sound effects, stickers, and effects, thereby making the conveyance of information and emotions more prominent. According to existing video processing algorithms, contents and texts of videos can be first automatically labeled and classified, and corresponding materials such as text templates and sound effects are matched according to a preset mapping rule strategy. The training costs of these methods are high, as video content classification and keyword classification rely on the determination of a classification system, data annotation, and a model training process, all of which incur relatively high costs in terms of time, annotation, and training. Additionally, these methods have poor scalability, as a mapping rule needs to be manually designed, and for new materials, a series of rule configurations are required to ensure effects, making it impossible to scale up. Therefore, how to improve the quality of video processing, make the videos more appealing, and expand the application scope of the materials have become urgent technical problems to be solved.

In view of this, embodiments of the present disclosure provide a video processing method and related devices. A video category and an effect object with at least one effect attribute label are automatically generated through attribute information of a target object and a target text corresponding to audio data, thereby forming a video effect list. Then, an appropriate effect material is selected according to the video category and the effect attribute label to be embedded in an initial video of the target object to obtain a target video. The content quality, viewing experience, and dissemination efficiency of the video can be significantly improved, making the video more appealing and more effective in information transmission.

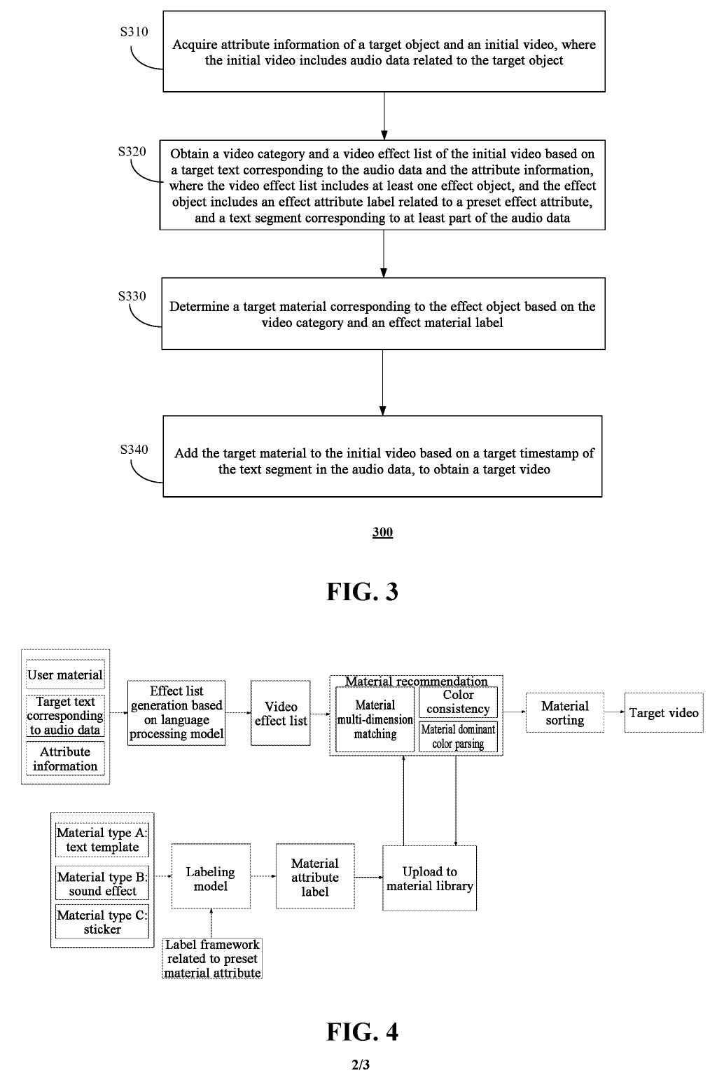

Referring to FIG. 3, FIG. 3 illustrates a schematic flowchart of a video processing method according to an embodiment of the present disclosure. The video processing method according to this embodiment of the present disclosure may be deployed on a terminal or a server side. In FIG. 3, the video processing method 300 may further include the following steps.

In step S310, attribute information of a target object and an initial video are acquired, where the initial video includes audio data related to the target object.

The target object may refer to a theme of the initial video to be processed, and all contents of the initial video revolve around the target object. The attribute information may refer to various features of the target object, such as a color, a size, a function, and a texture. The audio data may refer to sound information accompanying a video scene, such as a dialogue, background music, and an environmental sound effect. It should be understood that in the initial video, the attribute information may be presented to a viewer through introductions via scene display and the audio data (e.g., a voiceover).

Specifically, the target object may be a product to be recommended to the user, and corresponding attribute information may be product information. For example, the initial video video_1 may be an introduction related to the target object, and the attribute information Product Info of the target object may include: a product name, a product brand, a product selling point, a price, and promotion information. The attribute information may be data in a JSON format. The audio data studio may be voiceover or spoken copywriting in the initial video video_1, and a target text corresponding to the initial video video_1 may be obtained based on speech recognition. As shown in FIG. 4, FIG. 4 illustrates a schematic diagram of a video processing method according to an embodiment of the present disclosure.

In step S320, a video category and a video effect list of the initial video are obtained based on a target text corresponding to the audio data and the attribute information, where the video effect list includes at least one effect object, and the effect object includes an effect attribute label related to a preset effect attribute, and a text segment corresponding to at least part of the audio data.

The video category (video_category) may refer to a label or category describing a type of video content. The video effect list (effect_list) may be a list containing at least one effect object, and each effect object is designed to enhance the expressiveness of a specific part of the video. The effect object (effect_object) may refer to an element in the video effect list, used to indicate enhancing a specific part of the video. The effect attribute label (effect_attribute) may indicate an attribute of the effect object. The text segment (text_segment) may refer to text content in the audio data that is associated with the effect object and used to indicate time for applying an effect.

In some embodiments, the effect object also includes an effect weight, used to indicate the importance of the effect object. The effect weight (effect_weight) may refer to a display duration and/or display intensity of the effect object. For example, the effect weight (effect_weight) may be a value between 1 and 5, indicating the importance of the effect object, with 5 representing the highest importance.

Specifically, the target object may be furniture, and the initial video is a video of the furniture, introducing characteristics of the furniture, such as a load-bearing capacity and a reinforced edge. According to the target text corresponding to the audio data in the initial video, a video category ["Furniture", "Home Improvement"] may be generated, indicating that the video content is related to the furniture and home decoration. The video effect list generated based on the target text and the attribute information includes: an effect object 1 and an effect attribute thereof, and an effect object 2 and an effect attribute thereof. The effect object 1 and the effect object 2 may describe two important characteristics in the initial video, namely the load-bearing capacity and the reinforced edge of the furniture. By analyzing the audio data, relevant text segments of the two characteristics may be determined, and a series of effect attributes may be designed for each characteristic to highlight these characteristics in the target video. For example, for the characteristic of the "load-bearing capacity", a warm tone and bright brightness may be used to highlight the display, and a soft and minimalist font style may be selected. For the characteristic of the "reinforced edge", a neutral tone and bright brightness may be used, with the same soft font style but a different brightness. Through the method, a specific visual effect may be added to each important part of the video to enhance the expressiveness and appeal of the video.

In some embodiments, the step of obtaining a video category and a video effect list of the initial video based on a target text corresponding to the audio data and the attribute information includes:

generating an effect generation instruction for the initial video based on the target text, the attribute information, and a task prompt text;

in response to the effect generation instruction, performing video classification on the target text and the attribute information based on the task prompt text to obtain the video category;

dividing the target text into at least one text segment, with each text segment corresponding to each effect object;

classifying the preset effect attribute of the effect object based on the text segment and the attribute information to determine the effect attribute label of the preset effect attribute of the effect object from preset classification labels; and

forming the video effect list based on the effect attribute label of the effect object and the corresponding text segment.

The target text, the attribute information, and the task prompt text are used to automatically create the effect generation instruction for editing a video effect. For example, if the task prompt text requires adding a certain effect, time for adding the effect may be decided based on content of the target text and the attribute information. The target text is divided into a plurality of text segments, with each segment corresponding to one effect object in the video. For example, one video clip may focus on introducing an appearance of a product, while another clip may focus on functions of the product. The preset effect attribute of the effect object is classified according to the content of the text segment and the attribute information, thereby determining the effect attribute label suitable for each segment. For example, if a text segment mentions a unique design of a product, a visually prominent design effect may be selected. The video effect list is formed according to the effect attribute label of the effect object and the corresponding text segment, and contains various effects to be implemented in the video. For example, for a text segment emphasizing the innovativeness of a product, a futuristic animation effect may be added to the list. Through the method, the entire video can be automatically classified, and an appropriate effect may be added according to the content and the attribute information, thereby improving the quality and efficiency of video processing.

In some embodiments, the task prompt text includes at least one of the following: an input data format, an output data format, an input data example, an output data example, or a preset rule related to the effect attribute label.

Specifically, the task prompt text may be input into a language processing model to prompt the language processing model on how to specifically generate the video effect list. For example, the task prompt text may include: "In this task, you are playing the role of an experienced video editor who is skilled in video scriptwriting and post-production. Your ultimate goal is to design a post-production strategy for each shot to make the entire video more appealing. Task description: You will receive a video voiceover script that introduces a product, along with detailed product information (PRODUCT_INFO). Based on a specified preset effect attribute (EFFECT_ATTRIBUTE), you need to create a JSON object for a packaging element, containing two fields: a video category suitable for the video; and a video effect list including one or more effect objects. Each effect object may contain the following fields: a JSON object containing an effect attribute, and a text segment in the voiceover script that appears together with the effect object."

The preset effect attribute may have six feature dimensions: effect text: a character string displayed in the effect object, with a display style depending on an effect name; effect name: which may be of four different types, such as a price, possibly including a currency type and a number; discount amount: possibly including a percentage sign "%"; highlight: emphasizing key selling points or relevant details in a current shot; subscription: prompting user operations, such as following or purchasing; color style: a main color tone of the effect object, such as a warm tone, a cool tone, a neutral color, or a colorful style; color brightness: brightness of the effect object, such as bright or dim; color tone: a color tone of the effect object, including red, orange, yellow, green, blue, purple, pink, black, brown, gray, white, gold, silver, etc; and font style: a typographic style of the effect object, including minimalist, a magazine style, a business style, graffiti, a street style, high fashion, luxurious, soft and gentle, vintage, a cute style, innocent and fresh, a technology style, fashionably cool, 3D, a realistic style, bright, etc.

Input data is a JSON object, including the following fields: VOICEOVER: a punctuated character string representing the entire voiceover script of the video; and product information: a JSON object containing various attributes of a product. Output data may include two fields: video_category: a video category list suitable for the video; and a video effect list: a list including effect objects, where each object has fields such as an effect attribute, a text segment, and an effect weight. You need to create an appropriate video category and an effect list based on the input voiceover script and product information in conjunction with the effect attributes, to meet the needs of video production.

The preset rule related to the effect attribute label may include at least one of the following:

Unified visual style: all visual effects (e.g., a color, a tone, and a style) remain consistent to ensure overall aesthetics and harmony of the video. For example, in an output example, different effects use different color styles and brightness, but maintain an overall sense of harmony.

Effect list sequence: entries in an effect list may be arranged in a sequence of the entries in a voice description to ensure that no text paragraphs overlap between different effects.

Adherence to output format: the output must strictly follow the given JSON format to be correctly parsed by subsequent code, which includes all necessary keys and values, as well as correct data types and nested structures.

Effect text specifications: an effect_text attribute may not exceed a preset character count, such as 18 characters, and should accurately reflect an intended effect. It may not be identical to a text segment in the audio data but should convey the same core information.

Text paragraph specifications: a text_segment attribute needs to exactly match the target text corresponding to the corresponding audio data. For example, there is no need to convert the text into numbers or symbols, and the text is kept in an original form.

Price type effect: If a price is mentioned in the audio data, a price-type effect object may be included in the video effect list to highlight the display of price information and attract the viewer attention.

At least one highlight effect: at least one "Highlight" effect may be used in the effect object to emphasize key features or selling points of the product.

In step S330, a target material corresponding to the effect object is determined based on the video category and an effect material label.

In some embodiments, the step of determining a target material corresponding to the effect object based on the video category and the effect material label includes:

determining candidate materials in a material library based on the video category;

matching the effect material label with material labels of the candidate materials to obtain matching scores; and

determining the candidate material with the highest matching score as the target material.

Materials that conform to the video category are screened out from the material library as the candidate materials. For example, if the video category is "travel", materials related to travel, scenery, etc., are selected from the material library. Similarity between the candidate materials and the effect objects is reflected based on matching degrees between material labels of the candidate materials and the effect material labels. For example, if effect material labels include "dynamic" and "modern", candidate materials that match these labels may receive high matching scores. The candidate material with the highest matching score is determined as the target material to be added to the initial video. Specifically, an identifier (e.g., material ID) of the target material may be inserted into a corresponding effect object in the video effect list.

In some embodiments, matching the effect material label with material labels of candidate materials in a material library to obtain matching scores includes:

obtaining the matching scores of the candidate materials based on the material labels in the candidate materials that are consistent with the effect material label and corresponding label weights.

Considering the importance of different labels, the label weights may be used to adjust the matching scores. For example, for a material s in the video category, a label weight of an effect material label S1 is q1, a label weight of an effect material label S2 is q2, a label weight of an effect material label S3 is q3, and so on. If a material label of a certain candidate material is consistent with the effect material label S1 and the effect material label S2, a matching score of the candidate material may be q1+q2, and if a material label of a certain candidate material is consistent with the effect material label S1, a matching score of the candidate material may be q1.

In some embodiments, matching the effect material label with material labels of candidate materials in a material library to obtain matching scores further includes:

in response to the candidate material being consistent in style with another effect object, increasing a matching score of the candidate material by a preset value.

If a candidate material has a similar style to another effect object, a matching score of the candidate material will be additionally increased by a certain value. For example, for an effect object o1, if a candidate material s and another effect object o2 in the video effect list both have a bright and colorful style, a matching score of the candidate material s may be additionally increased by a preset value y. If a previous matching score of the candidate material s is q1+q2, the matching score of the candidate material s is q1+q2+y in this case. Therefore, materials with consistent styles may be used, thereby maintaining a consistent style for an overall video processing effect and improving the quality and effect of video processing.

In some embodiments, matching the effect material label with material labels of candidate materials in a material library to obtain matching scores further includes:

determining a recommendation weight for each of the candidate materials based on a historical usage amount, where the greater the historical usage amount, the smaller the corresponding recommendation weight; and

updating each of the matching scores based on a product of the recommendation weight and each of the matching scores.

The recommendation weight may be determined based on a frequency with which the candidate material has been used in the past. If a certain material has been frequently used in the past, its recommendation weight will be low; and conversely, if the material has rarely been used, its recommendation weight will be high. The recommendation weight is used to adjust the matching score to avoid overusing some materials. For example, if the candidate material s has the matching score of q1+q2 but its recommendation weight is x (due to frequent use), the adjusted matching score becomes (q1+q2)*x. To ensure the diversity and novelty of the materials, the system may also adjust recommendation weights for the candidate materials according to historical usage amounts. If one material has been frequently used in the past, its recommendation weight will be reduced, meaning that its matching score will be lowered, thereby decreasing the likelihood of the material being selected again. Through the method, the most appropriate material can be automatically selected for the video, meanwhile, the novelty and diversity of the materials are ensured, and the overall quality and viewing experience of the video are improved.

In some embodiments, the method 300 further includes:

acquiring an initial material;

parsing at least part of images in the initial material to obtain at least one material attribute label related to a preset material attribute; and

storing the initial material and the corresponding material attribute label in the material library.

The initial material may refer to initially collected and unprocessed data or resources. For example, the initial material may be a preview animated GIF image of a text template in the video. The material attribute label may refer to a label for describing a material feature or attribute. For example, the material attribute label may include a category of the initial material (e.g., a price type and a discount type) and other labels related to the visual effects. The material library may refer to a database or system that stores and manages materials and attribute labels thereof. For example, the material library may refer to an online database system used to store and maintain materials and corresponding labels.

The user analyzes an image by using the initial material as an input of a visual-audio model, and outputs a result according to a specified format, where the result includes different types of effect names and descriptions. A type may be determined according to a description, and a determination reason is output into a text effect type field. The output result may be presented in the JSON format, including fields such as a language, a color style, color brightness, dominant color extraction, a font style, and a video category. It should be understood that the fields of the above-mentioned preset material attribute are merely examples and are not intended to limit the preset material attribute. More preset material attributes and corresponding preset labels may also be set as needed, without any limitations.

Specifically, a series of classification and labeling tasks may be completed according to image data and a text effect of the initial material. Classification and labeling may include: language recognition: determining a language of the text effect and outputting a result as a character string to a language field, including language code, where optional languages include English, Chinese, Korean, Japanese, and other languages; color style classification: classifying a color style of the text effect and outputting a result as a character string to a color style field, where optional color styles include a warm tone, a cool tone, a neutral color, and a colorful style; brightness classification: classifying brightness of the text effect and outputting a result as a character string to a color brightness field, where optional brightness classifications include bright and dim; color tone: extracting dominant colors from the text effect and outputting colors that account for more than 30% of the proportion into a color tone field, which are arranged in descending order of proportion, where optional colors include red, orange, yellow, green, blue, purple, pink, black, brown, gray, white, gold, and silver; visual style determination: determining a visual style of the text effect and outputting a matched style to a visual style field, sorted by a matching degree, where optional visual styles include minimalist, a magazine style, a business style, graffiti, a street style, high fashion, luxurious, soft and gentle, vintage, a cute style, innocent and fresh, a technology style, fashionably cool, 3D, a realistic style, bright, etc; video category determination: determining a video category suitable for the text effect and outputting a result to a video category field, sorted by a degree of applicability, where optional product themes include an e-commerce platform, apparel and accessories, aesthetic nursing, food and beverage, electronics and home, sports and entertainment, maternity and childcare, pets, real estate rental, furniture and decoration, travel, education and training, gaming, finance, automobiles, utility software, professional services, a primary industry, a machinery industry, a general product theme, etc; and text effect name matching: determining an effect type that best matches the text effect and outputting a name to a text effect name field.

In some embodiments, parsing at least part of images in the initial material to obtain at least one material attribute label related to a preset material attribute includes:

selecting an image frame with the largest image area from the initial material;

classifying the image frame based on the preset material attribute to obtain a corresponding classification result; and

determining the classification result as a material attribute label related to the preset material attribute.

Specifically, a label system for classifying and describing material attributes may be determined, with a defined label framework, including several categories: a price type, a discount type, a subscription click-conversion type, a product feature highlight type, a user question type, and a user comment type. Additionally, labels related to the visual effects may also be defined. A trained labeling model may be used to automatically label the materials. For example, for an animated GIF, an image (image_max) with the largest proportion of a scene in the preview animated GIF from the text template may be extracted. Prompt information and the image (image_max) with the largest proportion are used to be input into the trained labeling model for labeling based on a plurality of dimensions (i.e., the preset material attributes). A labeled label result is stored in the system, ensuring easy access and updates to these labels. When a new raw material is available, labels may be pulled and maintained in real time through the labeling model. Therefore, the materials may be effectively organized and utilized, thereby improving the efficiency and quality of video processing.

In step S340, the target material is added to the initial video based on a target timestamp of the text segment in the audio data, to obtain a target video.

A timestamp indicating the appearance of the text segment may be positioned based on the target text, and is used for post production, such as synthesis of effect scripts, and the target material is added to the initial video to obtain the target video.

In some embodiments, the method 300 further includes:

preprocessing the text segment to obtain an intermediate segment in a text format;

performing similarity matching in the target text based on the intermediate segment to obtain a matched text segment; and

determining the target timestamp of the text segment based on the matched text segment and a text-timestamp mapping relationship, where the text-timestamp mapping relationship is obtained based on words in the target text and time when the words appear in the audio data.

Specifically, the target text corresponding to the audio data is merged into a continuous text character string, with spaces separating letters, numbers, or Chinese characters. A text-timestamp mapping relationship is established for each character in the merged text, mapping it to a word index in an original list, thereby tracking a specific word corresponding to each character and knowing a time position of the word in original audio data. For a text segment (text_segment) to be queried, there may be some inconsistencies (e.g., differences in numerical and textual forms) with an original text generated from speech-to-text conversion. Numbers in the text segment may be converted into a text form to maintain consistency with the original text. An edit distance algorithm is used to find a matched text segment closest to the preprocessed text segment, allowing for a certain degree of variation (e.g., extra or missing characters), and to find start and end positions of the matched text segment. The previously created text-timestamp mapping relationship is used to find an original word index corresponding to each character in the matched text segment. According to these indexes, start and end timestamps of each word are extracted from the original audio data. Therefore, a time position of a specific text segment in the original audio data can be effectively positioned and is used for subsequent video editing work, such as adding effect scripts or synthesizing packaging elements. Accordingly, an automatic video production process is facilitated, and working efficiency is improved.

It should be noted that the method in the embodiments of the present disclosure may be performed by a single device, such as a computer or a server. The method in the embodiments may also be applied to a distributed scenario to be completed through cooperation of a plurality of devices. In the distributed scenario, one of the plurality of devices may only perform one or more steps of the method in the embodiments of the present disclosure. The plurality of devices may interact with one another to complete the method.

It should be noted that some embodiments of the present disclosure are described above. Other embodiments are within the scope of the appended claims. In some cases, the actions or steps recited in the claims may be performed in a sequence different from that in the above-mentioned embodiments, and can still achieve desired results. In addition, the processes depicted in the accompanying drawings are not necessarily required to be shown in a particular or sequential sequence, to achieve desired results. In some implementations, multi-task processing and parallel processing are also possible or may be advantageous.

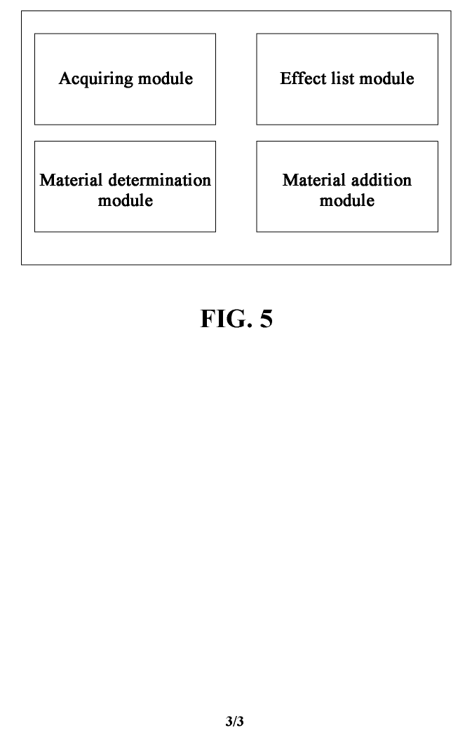

Based on the same technical concept, corresponding to the method in any of the above-mentioned embodiments, the present disclosure further provides a video processing apparatus. Referring to FIG. 5, the video processing apparatus includes:

an acquiring module, configured to acquire attribute information of a target object and an initial video , where the initial video includes audio data related to the target object;

an effect list module, configured to obtain, in language, a video category and a video effect list of the initial video based on a target text corresponding to the audio data and the attribute information, where the video effect list includes at least one effect object, and the effect object includes an effect attribute label related to a preset effect attribute, and a text segment corresponding to at least part of the audio data;

a material determination module, configured to determine a target material corresponding to the effect object based on the video category and the effect material label; and

a material addition module, configured to add the target material to the initial video based on a target timestamp of the text segment in the audio data, to obtain a target video.

For ease of description, the above-mentioned apparatus is described separately by dividing it into various functional modules. Certainly, functions of the modules may be implemented in one or more pieces of software and/or hardware when the present disclosure is implemented.

The apparatus of the above-mentioned embodiment is configured to implement the corresponding video processing method in any of the above-mentioned embodiments, and has the beneficial effects of the corresponding method embodiment. Details are not repeated herein.

Based on the same technical concept, corresponding to the method in any of the above-mentioned embodiments, the present disclosure further provides a non-transitory computer-readable storage medium, having computer instructions stored therein. The computer instructions are used to allow the computer to perform the video processing method in any of the above-mentioned embodiments.

The computer-readable medium in this embodiment includes permanent and non-permanent, removable and non-removable media and may implement information storage by using any method or technology. Information may be computer-readable instructions, a data structure, a program module, or other data. Examples of the computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read only memory (CD-ROM), a digital versatile disc (DVD) or other optical storage, a cassette tape, tape or disk storage or other magnetic storage devices, or any other non-transmission media that may be used to store information capable of being accessed by a computing device.

The computer instructions stored in the storage medium of the above-mentioned embodiment are used to allow the computer to perform the video processing method in any of the above-mentioned embodiments, and has the beneficial effects of the corresponding method embodiment. Details are not repeated here.

Those of ordinary skill in the art should understand that the discussion about any above-mentioned embodiment is exemplary and is not intended to imply that the scope (including the claims) of the present disclosure is limited to these examples; and under the idea of the present disclosure, technical features in the above-mentioned embodiments or in different embodiments may also be combined, the steps may be implemented in any sequence, and many other variations of different aspects in the above-mentioned embodiments of the present disclosure may exist, and for brevity, are not provided in detail.

In addition, to simplify the description and discussion, and to avoid making the embodiments of the present disclosure difficult to understand, known power/ground connections to an integrated circuit (IC) chip and other components may or may not be shown in the provided accompanying drawings. Further, the apparatus may be shown in the form of a block diagram to avoid obscuring an understanding of the embodiments of the present disclosure, and the following fact is also taken into account: details regarding the implementation of the apparatus in the block diagram are highly dependent upon a platform on which the embodiments of the present disclosure are to be implemented (i.e., such details should be fully within the understanding of those skilled in the art). When the specific details (e.g., a circuit) are elaborated to describe the exemplary embodiments of the present disclosure, it is apparent to those skilled in the art that the embodiments of the present disclosure may be implemented without these specific details or with variations of these specific details. Therefore, these descriptions should be considered illustrative rather than restrictive.

Although the present disclosure has been described with reference to the specific embodiments of the present disclosure, many substitutions, modifications, and variations of these embodiments will be apparent to those of ordinary skill in the art from the above-mentioned description. For example, the discussed embodiments may be used for other memory architectures (e.g., a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements, etc., made within the spirit and principle of the embodiments of the present disclosure shall fall within the scope of protection of the present disclosure.

We claim:

1. A method for video processing, comprising:
acquiring attribute information of a target object and an initial video, the initial video comprising audio data related to the target object;
obtaining a video category and a video effect list of the initial video based on a target text corresponding to the audio data and the attribute information, wherein the video effect list comprises at least one effect object, and the effect object comprises an effect attribute label related to a preset effect attribute, and a text segment corresponding to at least part of the audio data;
determining a target material corresponding to the effect object based on the video category and an effect material label; and
adding the target material to the initial video based on a target timestamp of the text segment in the audio data to obtain a target video.

2. The method according to claim 1, wherein determining the target material corresponding to the effect object based on the video category and the effect material label comprises:
determining candidate materials in a material library based on the video category;
matching the effect material label with material labels of the candidate materials to obtain matching scores; and
determining a candidate material with the highest matching score as the target material.

3. The method according to claim 2, wherein matching the effect material label with the material labels of the candidate materials in the material library to obtain the matching scores comprises:
obtaining the matching scores of the candidate materials based on the material labels in the candidate materials that are consistent with the effect material label and corresponding label weights.

4. The method according to claim 3, wherein matching the effect material label with the material labels of the candidate materials in the material library to obtain the matching scores further comprises:
in response to at least two of the candidate materials being consistent in style, increasing the matching scores of the candidate materials by a preset value; or,
determining a recommendation weight for each of the candidate materials based on a historical usage amount, wherein the greater the historical usage amount, the smaller the corresponding recommendation weight; and
updating each of the matching scores based on a product of the recommendation weight and each of the matching scores.

5. The method according to claim 1, wherein obtaining the video category and the video effect list of the initial video based on the target text corresponding to the audio data and the attribute information comprises:
generating an effect generation instruction for the initial video based on the target text, the attribute information, and a task prompt text;
in response to the effect generation instruction, performing, based on the task prompt text, video classification on the target text and the attribute information to obtain the video category;
dividing the target text into at least one text segment, wherein each text segment corresponds to each effect object;
classifying the preset effect attribute of the effect object based on the text segment and the attribute information to determine the effect attribute label of the preset effect attribute of the effect object from preset classification labels; and
forming the video effect list based on the effect attribute label of the effect object and the corresponding text segment.

6. The method according to claim 1, further comprising:
preprocessing the text segment to obtain an intermediate segment in a text format;
performing similarity matching in the target text based on the intermediate segment to obtain a matched text segment; and
determining the target timestamp of the text segment based on the matched text segment and a text-timestamp mapping relationship, wherein the text-timestamp mapping relationship is obtained based on words in the target text and time when the words appear in the audio data.

7. The method according to claim 1, further comprising:
acquiring an initial material;
parsing at least part of images in the initial material to obtain at least one material attribute label related to a preset material attribute; and
storing the initial material and the corresponding material attribute label in a material library.

8. The method according to claim 7, wherein parsing at least part of images in the initial material to obtain the at least one material attribute label related to the preset material attribute comprises:
selecting an image frame with the largest image area in the initial material;
classifying the image frame based on the preset material attribute to obtain a corresponding classification result; and
determining the classification result as the material attribute label related to the preset material attribute.

9. The method according to claim 1, wherein the effect object further comprises an effect weight used to indicate a display duration and/or display intensity of the effect object; or
the task prompt text comprises at least one of: an input data format, an output data format, an input data example, an output data example, or a preset rule related to the effect attribute label.

10. An electronic device, comprising a memory, a processor, and a computer program stored on the memory and executable on the processor, wherein the program, when executed by the processor, causes the processor to:
acquire attribute information of a target object and an initial video, the initial video comprising audio data related to the target object;
obtain a video category and a video effect list of the initial video based on a target text corresponding to the audio data and the attribute information, wherein the video effect list comprises at least one effect object, and the effect object comprises an effect attribute label related to a preset effect attribute, and a text segment corresponding to at least part of the audio data;
determine a target material corresponding to the effect object based on the video category and an effect material label; and
add the target material to the initial video based on a target timestamp of the text segment in the audio data to obtain a target video.

11. The electronic device according to claim 10, wherein the program causing the processor to determine the target material corresponding to the effect object based on the video category and the effect material label further causes the processor to:
determine candidate materials in a material library based on the video category;
match the effect material label with material labels of the candidate materials to obtain matching scores; and
determine a candidate material with the highest matching score as the target material.

12. The electronic device according to claim 11, wherein the program causing the processor to match the effect material label with the material labels of the candidate materials in the material library to obtain the matching scores further causes the processor to:
obtain the matching scores of the candidate materials based on the material labels in the candidate materials that are consistent with the effect material label and corresponding label weights.

13. The electronic device according to claim 12, wherein the program causing the processor to match the effect material label with the material labels of the candidate materials in the material library to obtain the matching scores further causes the processor to:
in response to at least two of the candidate materials being consistent in style, increase the matching scores of the candidate materials by a preset value; or
determine a recommendation weight for each of the candidate materials based on a historical usage amount, wherein the greater the historical usage amount, the smaller the corresponding recommendation weight; and
update each of the matching scores based on a product of the recommendation weight and each of the matching scores.

14. The electronic device according to claim 10, wherein the program causing the processor to obtain the video category and the video effect list of the initial video based on the target text corresponding to the audio data and the attribute information further causes the processor to:
generate an effect generation instruction for the initial video based on the target text, the attribute information, and a task prompt text;
in response to the effect generation instruction, perform, based on the task prompt text, video classification on the target text and the attribute information to obtain the video category;
divide the target text into at least one text segment, wherein each text segment corresponds to each effect object;
classify the preset effect attribute of the effect object based on the text segment and the attribute information to determine the effect attribute label of the preset effect attribute of the effect object from preset classification labels; and
form the video effect list based on the effect attribute label of the effect object and the corresponding text segment.

15. The electronic device according to claim 10, the program further causes the processor to:
preprocess the text segment to obtain an intermediate segment in a text format;
perform similarity matching in the target text based on the intermediate segment to obtain a matched text segment; and
determine the target timestamp of the text segment based on the matched text segment and a text-timestamp mapping relationship, wherein the text-timestamp mapping relationship is obtained based on words in the target text and time when the words appear in the audio data.

16. The electronic device according to claim 10, the program further causes the processor to:
acquire an initial material;
parse at least part of images in the initial material to obtain at least one material attribute label related to a preset material attribute; and
store the initial material and the corresponding material attribute label in a material library.

17. The electronic device according to claim 16, wherein the program causing the processor to parse at least part of images in the initial material to obtain the at least one material attribute label related to the preset material attribute the program further causes the processor to:
select an image frame with the largest image area in the initial material;
classify the image frame based on the preset material attribute to obtain a corresponding classification result; and
determine the classification result as the material attribute label related to the preset material attribute.

18. The electronic device according to claim 10, wherein the effect object further comprises an effect weight used to indicate a display duration and/or display intensity of the effect object; or
the task prompt text comprises at least one of: an input data format, an output data format, an input data example, an output data example, or a preset rule related to the effect attribute label.

19. A non-transitory computer-readable storage medium, wherein the non-transitory computer-readable storage medium stores computer instructions, and the computer instructions, when executed by a computer, cause the computer to:
acquire attribute information of a target object and an initial video, the initial video comprising audio data related to the target object;
obtain a video category and a video effect list of the initial video based on a target text corresponding to the audio data and the attribute information, wherein the video effect list comprises at least one effect object, and the effect object comprises an effect attribute label related to a preset effect attribute, and a text segment corresponding to at least part of the audio data;
determine a target material corresponding to the effect object based on the video category and an effect material label; and
add the target material to the initial video based on a target timestamp of the text segment in the audio data to obtain a target video.

20. The non-transitory computer-readable storage medium according to claim 19, wherein the computer instructions causing the computer to determine the target material corresponding to the effect object based on the video category and the effect material label further cause the computer to:
determine candidate materials in a material library based on the video category;
match the effect material label with material labels of the candidate materials to obtain matching scores; and
determine a candidate material with the highest matching score as the target material.
